(19) United States
(12) Patent Application Publication
(10) Pub. No.: US 2010/0295328 A1
(43) Pub. Date: Nov. 25, 2010

(54) Cookie dunking spoon

(76) Inventor: Anthony S. Fiorino, Woodstock, MD (US)

Correspondence Address: RUTH EURE, 4795 EDISON AVENUE, BOULDER, CO, 80301, US

(21) Appl. No.: 12/800,225

(22) Filed: May 10, 2010

Related U.S. Application Data
(60) Provisional application No. 61/179,826, filed on May 20, 2009.

(51) Int. Cl. A47J 43/28; A47G 21/00

(52) U.S. Cl. 294/137

(57) ABSTRACT

The present invention provides a cookie dunking spoon comprising an elongate handle having a first end and a second end which terminates in a drain tray at its first end and a hook at its second end.

The cookie dunking spoon of the present invention is an item that can hold a cookie for dunking in a beverage so the user can easily consume the moistened cookie. This item comprises a spoon with a drain tray of any suitable configuration, such as waffle shaped, for example.

### CLAIM OF PRIORITY

This patent application claims priority under 35 USC119(e)(1) from U.S. Provisional Patent Application Ser. No. 61/179,826, filed May 20, 2009, of common inventorship herewith entitled, ‘Cookie Dunking Spoon’.

### FIELD OF THE INVENTION

This invention relates to a method of cookie handling apparatus, specifically to such apparatus which are used for dunking cookies into liquids contained in a vessel used for consumable liquids.

### BACKGROUND OF THE INVENTION

There are many people who enjoy dunking cookies or other food items in a glass of milk, coffee or other beverage. This is easy at first, when the cup is full, but as the beverage begins to decrease, it becomes increasingly difficult to dunk a cookie into it and retrieve the cookie. The user may tilt the cup to dunk or stick his or her hand into the cup to reach the remaining beverage. This can be a difficult task for a person with large hands or a narrow cup and may make a mess in the process. Children especially may create a mess of spilled liquid and crumbles. Some individuals may be uncomfortable having their fingers, and germs that may be on their hands, placed in a liquid that will be consumed. Having a simple, clean and hygienic way to dunk cookies assists individuals in doing so without creating a mess.

The prior art has put forth several designs for food handling apparatus. Among these are:

US Patent Application publication 2007/0068948 to David Friedman is a patent application which describes a hand-held food immersing apparatus which allows a user to dip a food item in a container of liquid. The apparatus includes a handle portion adapted to facilitate the user's grip and a plurality of flexible, elongated, and outwardly curved members adapted to firmly grasp the food item. The apparatus described is large and seemingly cumbersome.

US Patent Application publication 2006/0021989 to David Friedman is a patent application which describes a Beverage Container for Immersing Food including an open container, a holder defining an area adapted to hold food, and a handle. The holder fits within the open container and has a first magnetic portion such that when the holder is in the container, the first magnetic portion is adjacent an interior part of the walls of the container. The handle has a second magnetic portion such that when the second magnetic portion of the handle is placed adjacent an exterior part of the holder, a magnetic bond is formed between the two magnets permitting movement of the handle to control movement of the holder.

US Patent Application publication 2006/0021990 to David Friedman is a patent application describing Food Immersing Apparatus for Beverage Container is adapted to be retrofit onto an open beverage container having walls continuously connected to a substantially horizontal base. The apparatus includes a holder defining an area adapted to hold food that fits within the container. An elongated member couples a handle to the holder. The elongated member extends out of the container over its walls and down at least a portion of an exterior part of its wells. The handle can be attached to the elongated member at the top of the container or along the part that extends downward.

None of these prior art references describe the present invention.

### SUMMARY OF THE INVENTION

It is an object of the present invention to provide cookie immersion capability to the user. The cookie dunking spoon of the present invention allows the user to immerse and moisten a cookie or any food item for easy and controlled consumption without having to use fingers to hold the food item. This apparatus is ideal for use by anyone for a simple and clean way to dip their cookies in a liquid without leaving spills and crumbs behind.

The present invention, hereinafter referred to as the Cookie Dunking Spoon, is a spoon with a drain tray. The drain tray can be any suitable configuration, such as waffle-shaped, for example.

In an embodiment, a slight lip/edge around the back section of the tray holds a cookie/food item in place. The ergonomic handle extends into a curbed U-shaped section a suitable length, for example approximately 2.5 inches. This allows the spoon to rest on the rim of a cup.

In an embodiment, the flat tray portion on the handle is stamped out to have the face of cartoon characters, holiday objects, sports symbols and other themes thereon.

The present invention is produced from any suitable material such as metal or plastic, such as a lightweight plastic or another similar material, for example. This present invention can be available in various sizes and colors to accommodate user preferences and needs. The exact dimensions and materials used for construction and method of operation of Cookie Dunking Spoon are variable.

### DESCRIPTION OF THE DRAWINGS

FIG. 1 shows a child using the product.

FIG. 2 shows the product in multiple variations.

FIG. 3 shows the unit resting on the rim of a glass of liquid.

FIG. 4 shows the handle of the product being grasped to dunk a cookie.

FIG. 5 shows a cookie being raised from a glass of milk with the excess liquid draining off.

FIG. 6 shows a sketch of the apparatus.

FIG. 6a shows the drain plate.

FIG. 6b shows drainage hole(s).

FIG. 6c shows U-shaped section of drain plate which retains cookie on drain plate.

FIG. 6d shows stem of handle.

FIG. 6e shows stamped area for artwork and thumb rest.

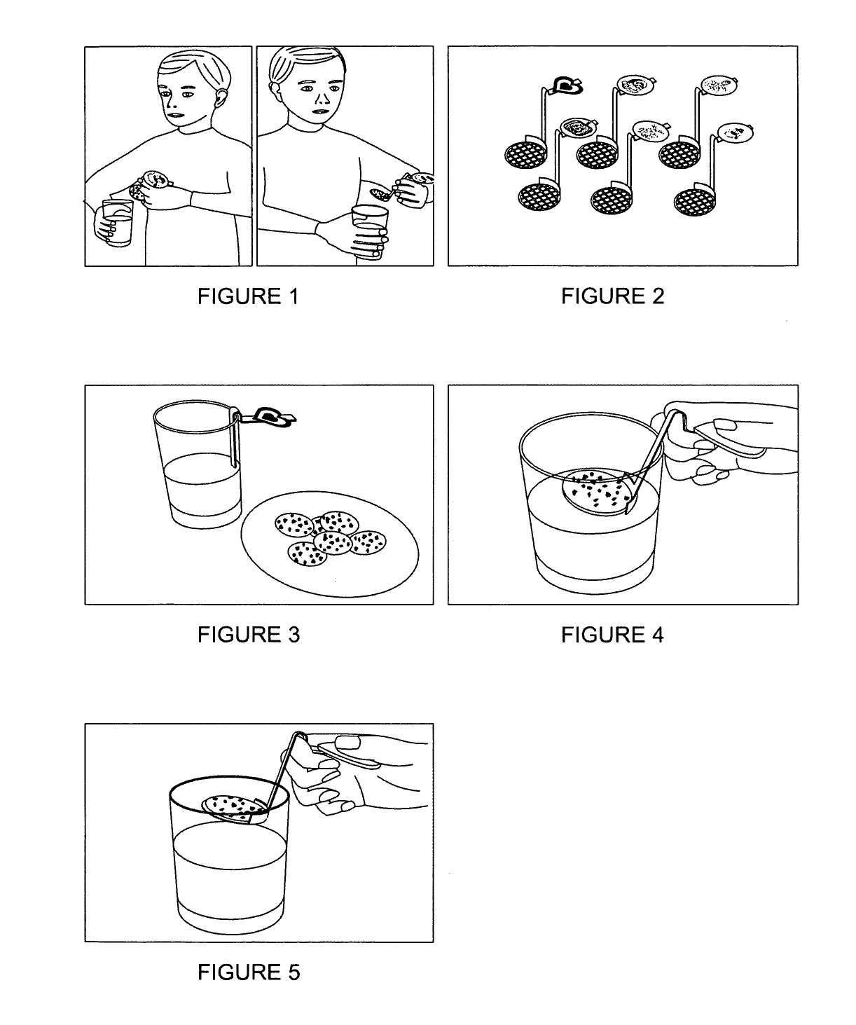

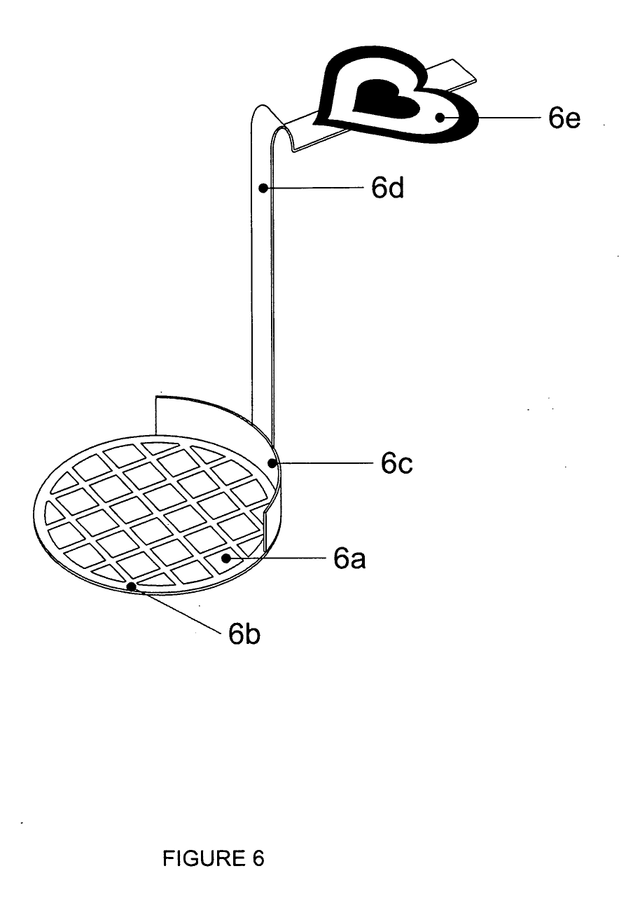

### DETAILED DESCRIPTION OF THE INVENTION

The present invention comprises a cookie dunking spoon comprising an elongate handle having a first end and a second end which terminates in a drain tray at its first end and a hook at its second end.

The cookie dunking spoon of the present invention is an item that can hold a cookie for dunking in a beverage so the user can easily consume the moistened cookie. This item comprises a spoon with a drain tray of any suitable configuration, such as waffle shaped, for example.

In one embodiment, a slight lip/edge around the back section of the tray holds a cookie/food item in place. The ergonomic handle extends” into a curved U-shaped section. This allows the spoon to rest on the rim of a cup.

In an alternative embodiment, a flat portion found on the handle can be stamped out to have the face of cartoon characters, holiday objects, sports symbols and other themes. The present invention can be produced from any suitable material such as a lightweight plastic, metal or another similar material. This present invention can be available in various sizes and colors to accommodate user preferences and needs. The exact dimensions, materials used for construction and method of operation of Cookie Dunking spoon vary upon manufacturing.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A hand-held cookie holding apparatus to allow a user to hold, control, and dip a cookie into a container of liquid, the apparatus comprising;
a handle having a first end and a second end having a plurality of possible spatial configurations;
the first end comprising a flat portion found on the handle may be stamped out to have the face of cartoon characters, holiday objects, sports symbols or other themes;
the second end comprising a drainage plate with drainage opening configurations to allow the liquid to drain back into the container when apparatus is lifted out of the container; and
a U-shaped retaining edge partially circumventing the drainage plate at the handle attachment.

2. The apparatus of claim 1 wherein the possible spatial configurations correspond to different shapes such as straight, bent, serpentine and hooked handle elements.

3. The apparatus of claim 1, wherein the drainage openings are selected from the group consisting of round holes, oval holes, heart-shaped holes and rectangles.

4. The apparatus of claim 1, wherein the stamped flat portion of handle portrays indicia such as cartoon characters, holiday objects or symbols, sports themes and a plurality of other artwork images.
